(19) United States
(12) Patent Application Publication
(10) Pub. No.: US 2003/0146612 A1
(43) Pub. Date: Aug. 7, 2003

(54) Inflator and closure-fixing structure of the same

(75) Inventor: Makoto Doi, Hikone-shi (JP)

Correspondence Address: KANESAKA AND TAKEUCHI, 1423 Powhatan Sheet, Alexandria, VA, 22314, US

(73) Assignee: TAKATA CORPORATION

(21) Appl. No.: 10/347,307

(22) Filed: Jan. 21, 2003

(30) Foreign Application Priority Data
Feb. 7, 2002 (JP) 2002-031049

(51) Int. Cl. B60R 21/26

(52) U.S. Cl. 280/741

(57) ABSTRACT

A closure is inserted into a casing for closing one end of the casing. A projecting portion projecting from an inner peripheral surface of the casing is formed at a position slightly away from the one end of the casing. The projecting portion is formed as a projecting rib around a periphery of the casing. After the closure is inserted into the casing, the closure engages the projecting portion. An edge of the casing is bent toward the inside of the casing, so that the closure is sandwiched and fixed by the projecting portion and the edge. The closure may be subjected to a coining process to closely fix the closure to the casing.

### BACKGROUND OF THE INVENTION AND RELATED ART STATEMENT

The present invention relates to an inflator for generating a gas used for an air bag apparatus, and also relates to a closure-fixing structure of the inflator.

An air bag apparatus mounted to an automobile and the like includes an inflator (gas generator) for quickly expanding an air bag. A cylindrical inflator is used for, for example, a passenger-side air bag apparatus. Such a cylindrical inflator may also be used for a driver-side air bag apparatus, a head-protecting air bag apparatus, a side air bag apparatus, and a pedestrian-protecting air bag apparatus.

The cylindrical inflator includes a type in which an end of a cylindrical casing is closed by a closure (sealing plate) and the casing is filled with a gas generator. One conventional example of this type will be described with reference to FIGS. 4 and 5.

An inflator 10 includes a cylindrical casing 12, closures (sealing plates) 14 and 16 for closing both ends of the casing 12, an initiator 18 fixed to one closure 14, a cylindrical filter 20 arranged along an inner periphery of the casing 12, a booster propellant 22, a wafer propellant 24, a spring 26 for pushing the wafer propellant 24, and O-rings 28 for sealing outer peripheries of the closures 14 and 16.

When the initiator 18 is energized, the initiator 18 is actuated to jet a gas, and the gas initiates the booster propellant 22 to start a reaction to generate a gas. Subsequently, the reaction gas of the booster propellant 22 contacts the wafer propellant 24 to start a reaction thereof to generate a gas. Then, the gas jets out from gas exhaust nozzles 30 of the casing 12 to expand an air bag.

In the conventional inflator 10, when the closures 14 and 16 are fastened to the casing 12, after the closure 14 or 16 is inserted into the cylindrical casing 12 before the end is bent, an edge 12a of the casing 12 is bent inwardly, as shown in FIG. 5. At that time, the filter 20 supports an inner plane of the closure 14 or 16 inside the casing. In other words, a pushing force applied to the closure 14 or 16 so as to push toward the inside of the casing when bending the edge 12a is opposed to the filter 20.

FIG. 6(a) is a sectional view showing a fixing structure of a closure 32 and a casing 34 according to another conventional example, and FIG. 6(b) is a side view of the closure 32.

In this conventional example, an edge of the casing 34 is shaped to decrease in diameter inwardly in advance. After a shoulder 32a at an outer periphery of the closure 32 contacts an edge of the casing 34, the closure 32 and the casing 34 are welded together. A reference numeral 36 denotes a welding metal.

As shown in FIGS. 4 and 5, in the case of the configuration in which the edges 12a of the casing 12 are bent to fix the closures 14 and 16, the closures 14 and 16 are supported by the filter 20. Therefore, the filter 20 is required to have sufficient strength and rigidity.

As shown in FIGS. 6(a) and 6(b), in the case of the configuration in which the closure 32 is welded to the casing 34, both the casing 34 and the closure 32 are required to be formed of a material that can be welded, thereby limiting a material for the casing 34 and the closure 32.

Accordingly, an object of the present invention is to provide a closure-fixing structure of an inflator that allows a filter to have lower strength and rigidity.

Another object of the present invention is to provide a closure-fixing structure of an inflator that can also be applied to a casing and a closure made of various materials.

A further object of the present invention is to provide a closure-fixing structure to obtain sufficient airtight bonding between the closure and the casing without an O-ring around the outer periphery of the closure.

A still further object of the present invention is to provide an inflator that employs such a closure-fixing structure.

Further objects and advantages of the invention will be apparent from the following description of the invention.

### SUMMARY OF THE INVENTION

In a closure-fixing structure of the present invention, a disc-shaped closure is inserted into an end of a cylindrical casing and an edge of the casing is bent inwardly to fix the closure to the casing. A projecting portion projecting from an inner surface of the casing is provided at a position closer to the center of the casing relative to the closure in the cylinder axis direction, and the closure is engaged with the projecting portion.

With such a closure-fixing structure, since the projecting portion of the casing supports the closure when the edge of the casing is bent, a load upon bending of the edge is not applied to a filter. Therefore, strength and rigidity required for the filter can be remarkably reduced. Also, this allows the reduction of the production cost of the inflator.

Preferably, the projecting portion is formed by a process of projecting the casing inwardly. Consequently, the projecting portion can be remarkably easily formed, so that the production cost of the casing can be reduced.

According to the present invention, preferably, the outer peripheral surface of the closure is closely adhered to the inner peripheral surface of the casing by applying a coining process to the closure fixed to the casing.

Further, in a closure-fixing structure of an inflator of the present invention, a disc-shaped closure is inserted into an end of a cylindrical casing and an edge of the casing is bent inwardly. An outer peripheral surface of the closure is closely fitted to an inner peripheral surface of the casing by applying a coining process to the closure fixed to the casing.

By applying the coining process as described above, the outer peripheral surface of the closure is closely fitted to the inner peripheral surface of the casing, so that the inner peripheral surface of the casing and the outer peripheral surface of the closure can sufficiently be bonded airtightly even without an O-ring.

According to the present invention, an inflator includes a cylindrical casing with an end closed by a closure, a gas generator filled in the casing, and reaction starting means for the gas generator. The closure is fixed to the casing with the aforementioned closure-fixing structure of the present invention. The inflator can reduce a production cost, thereby reducing a cost of an air bag apparatus.

### BRIEF DESCRIPTION OF THE DRAWINGS

FIGS. 1(a) to 1(f) are views showing a closure-fixing structure according to an embodiment, wherein FIG. 1(a) is a perspective view of the end of a casing, FIGS. 1(b), 1(c), 1(d), and 1(e) are sectional views thereof, and FIG. 1(f) is a perspective view of a closure after coining;

FIGS. 2(a) to 2(e) are plan views showing examples of a groove shape of the closure after coining;

FIGS. 3(a) and 3(b) are perspective views showing examples of a shape of a projecting portion provided to the casing;

FIG. 4 is a sectional view of a conventional inflator;

FIG. 5 is a sectional view showing a manufacturing method of the inflator shown in FIG. 4; and

FIG. 6(a) is a sectional view showing another conventional example, and FIG. 6(b) is a side view of the closure.

### DETAILED DESCRIPTION OF PREFERRED EMBODIMENTS

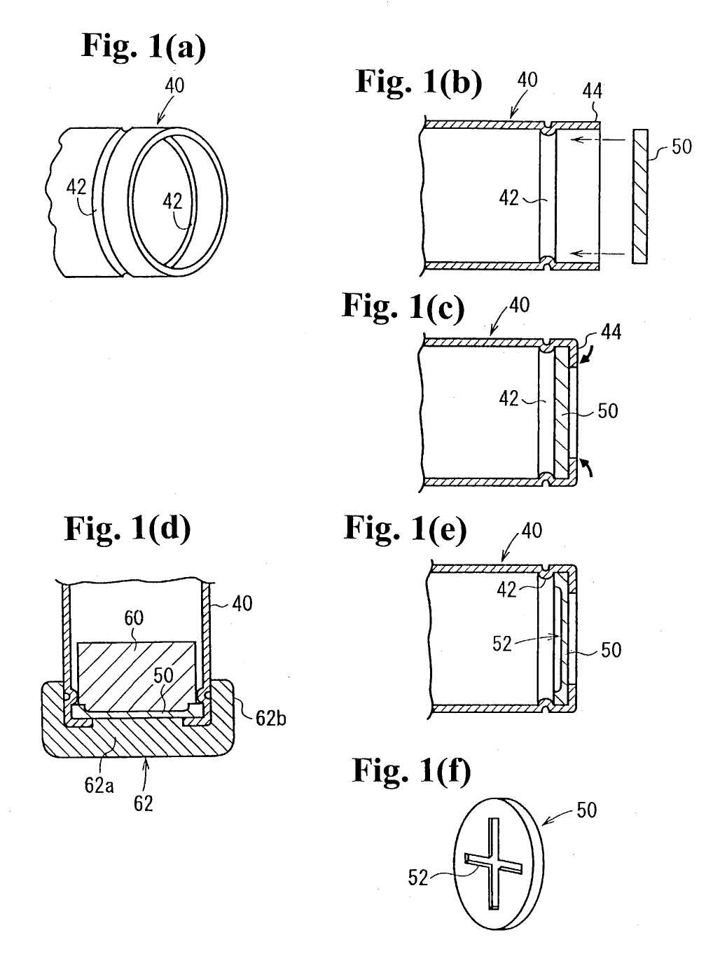

Hereunder, embodiments of the present invention will be described with reference to the accompanying drawings. FIGS. 1(a) to 1(f) are views showing a closure-fixing structure according to the embodiment.

In this embodiment, as shown in FIGS. 1(b) to 1(e), a disc-shaped closure (sealing plate) 50 is inserted into one end of a cylindrical casing 40, and an edge 44 of the casing 40 is bent inwardly to fix the closure 50.

As clearly shown in FIGS. 1(a) and 1(b), a projecting portion 42 projecting from an inner peripheral surface of the casing 40 is formed at a position away from the end of the casing 40 by a predetermined distance. In this embodiment, the projecting portion 42 is formed as a projecting rib around the periphery of the casing 40. The projecting portion 42 is formed with a beading (drawing) process to the casing 40. The closure 50 is inserted into the casing 40 before the edge 44 is bent, and engages the projecting portion 42.

Subsequently, as shown in FIG. 1(c), the edge 44 is bent toward the inside of the casing 40, that is, toward the center of the diameter by pressing to hold the closure 50. As a result, the closure 50 is sandwiched and fixed between the projecting portion 42 and the edge 44.

Next, as shown in FIG. 1(d), the closure 50 is subjected to a coining process whereby the closure 50 is intensely pressurized by a coining die 60 and a fixing die 62. The fixing die 62 includes a base 62a overlapping with an outer plane of the closure 50 and a ring 62b surrounding the outer periphery at the one end of the casing 40. In this embodiment, a cross-shaped projecting rib (not shown) is provided at the end face of the coining die 60. In the coining process, the cross-shaped projecting rib encroaches a plate surface of the closure 50 inside the casing 40 (near the center of the shaft axis of the casing 40) to form a cross-shaped groove 52 in the plane inside the closure 50, as shown in FIG. 1(f).

Since the casing 40 is restrained by the ring 62b of the fixing die 62 from the outer periphery, the closure 50 is plastically deformed so as to expand in the radial direction, so that the outer peripheral surface of the closure 50 is strongly pressed to the inner peripheral surface of the casing 40 to be brought into close contact therewith. Accordingly, the outer peripheral surface of the closure 50 and the inner peripheral surface of the casing 40 are hermetically sealed.

According to this embodiment, when the edge 44 of the casing 40 is bent, the projecting portion 42 supports the closure 50, so that a bending load is not applied to a filter (not shown in FIGS. 1(a)-1(e)). Therefore, the filter is required to have less strength and rigidity. This allows employing a filter having only such original functions of a filter as capturing particulates (very fine particles) in a reaction gas and reducing a gas temperature. Also, since the closure 50 and the casing 40 are not welded together, the casing 40 and the closure 50 can be formed of a material other than a welding material, thus offering a wide choice of materials.

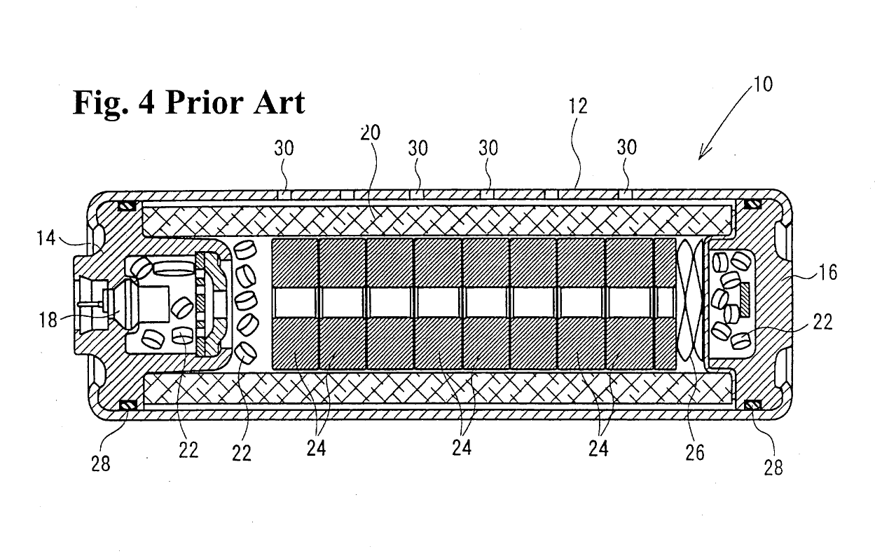

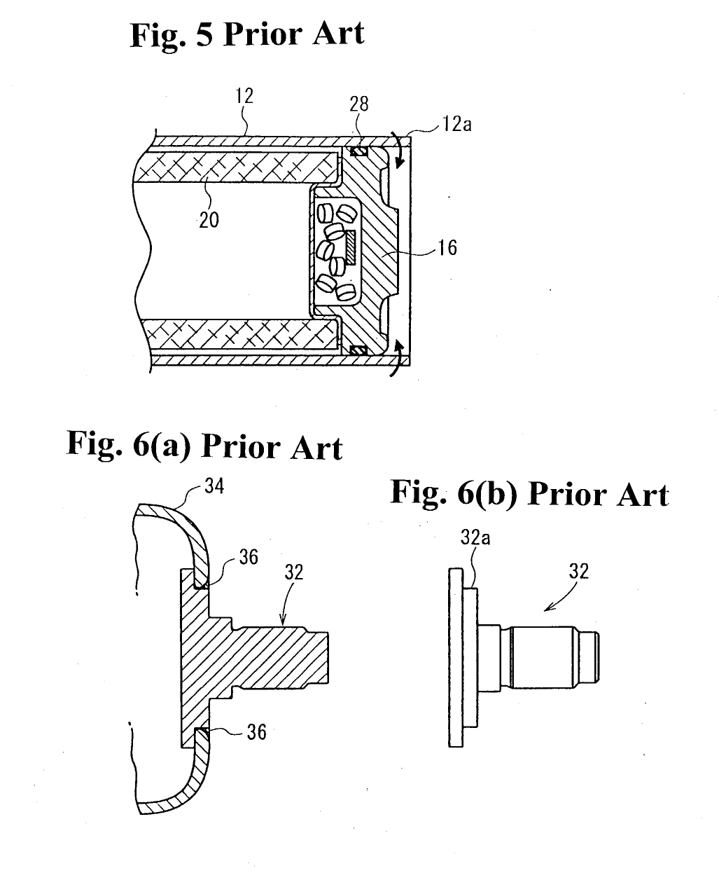

In the embodiment of FIGS. 1(a)-1(f), the closure 50 is shaped in a disc, so that a shape and a structure are simpler than those of the closures 14, 16 and 32 shown in FIGS. 4 to 6, thereby reducing a production cost. In order to bend the edge 44 of the casing 40, a press with a simple structure can be used, thereby further reducing a cost for production facilities.

In the embodiment shown in FIGS. 1(a) to 1(f), the casing 40 includes the projecting portion 42. However, it is also possible to fix the closure to the casing only by the coining process with no projecting portion 42. In this case, the edge 44 at one end of the casing 40 is bent inwardly in advance, as in FIG. 1(c). Then, after the closure 50 is inserted into the casing 40 from the other end of the casing 40 (not shown), the coining process is applied, as in FIG. 1(d), to fit the outer peripheral surface of the closure 50 to the inner peripheral surface of the casing 40 closely and to fix the closure 50 to the casing 40.

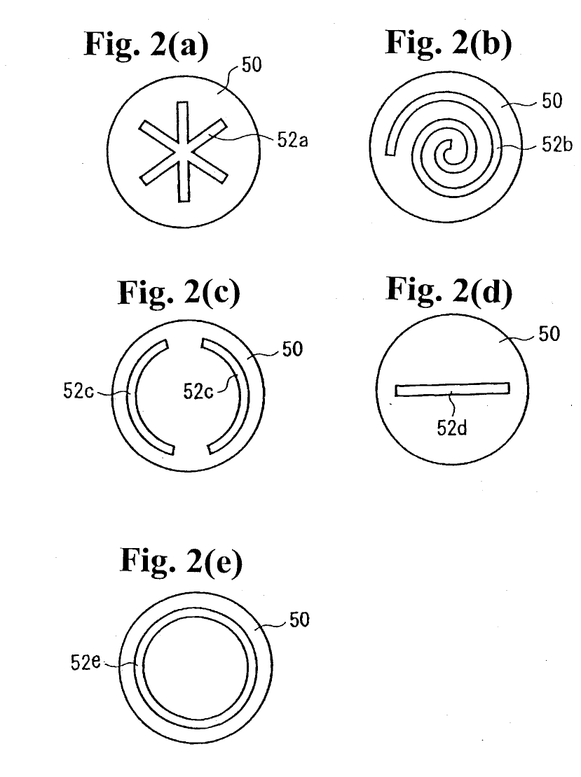

The embodiments described above are only examples of the present invention, and the present invention is not limited to the embodiments. For example, the shape of the projecting rib provided on the end face of the coining die 60 is not limited to the cross shape, but may be various shapes such as an annular ring shape, a star shape, a spiral shape, a circular arch shape, and a straight-line shape. FIGS. 2(a) to 2(e) show the shapes of the groove of the closure 50 formed by the projecting ribs of the coining die with such shapes described above.

A groove 52a of FIGS. 2(a) extends in six radial directions. Also, it may be a groove that extends in three directions, five directions, or seven directions or more. Also, a groove 52b of FIG. 2(b) is shaped in a spiral. In FIG. 2(b), the spiral is substantially double; however, it may be a multiple spiral.

A groove 52c of FIG. 2(c) is shaped in an almost semicircular arc. Two grooves 52c extend along the periphery of the closure 50. Also, it may be a circular-arc-shaped groove shorter than the groove 52c. For example, four grooves shaped in a substantially one-quarter of a circular arc may be formed around the periphery of the closure 50. Of course, it is obvious that the grooves may have various lengths, such as three grooves shaped in a substantially one-third of a circular arc.

A groove 52d of FIG. 2(d) is shaped in a straight line, extending in the diameter direction of the closure 50. Further, a groove 52e of FIG. 2(e) is shaped in an annular ring, extending along the periphery of the closure 50.

In the coining process, the groove may be provided only in the plane of the closure 50 inside the casing 40, but also in an outer plane. In this case, a projecting rib is provided on the surface of the base 62a, which overlaps with the outer plane of the closure 50 of the fixing die 62. At that time, it is preferable to place the fixing die 62 and the coining die 60 with a gap so as not to overlap with each other in the axial direction.

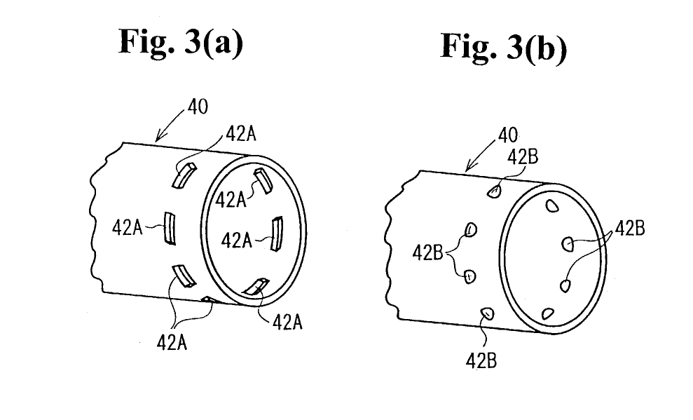

In the embodiment of FIGS. 1(a)-1(f), although the projecting portion 42 is provided along the whole circumference of the casing 40, a plurality of projecting portions 42A may be intermittently provided at fixed intervals in the circumferential direction, as shown in FIG. 3(a). In FIG. 3(a), the projecting portions 42A extend in a fixed length in the circumferential direction of the casing 40. However, dimple-shaped projecting portions 42B shaped in an almost hemispherical shell may be provided with a fixed interval in the circumferential direction of the casing, as shown in FIG. 3(b). In this embodiment, an O-ring may be mounted around the outer periphery of the closure.

As described above, according to the present invention, the closure can be fixed to the end of the casing easily and firmly. Also, a wide choice of materials for the casing and the closure is offered.

While the invention has been explained with reference to the specific embodiments of the invention, the explanation is illustrative and the invention is limited only by the appended claims.

What is claimed is:

1. A closure-fixing structure, comprising:
a casing formed in a cylindrical shape and having two ends to be bent radially inwardly of the casing,
a closure formed in a disk shape to be inserted into the casing from one of the two ends of the casing for closing the one end, and
at least one projecting portion provided on an inner surface of the casing to project radially inwardly of the casing, said closure inserted into the casing being held between the at least one projecting portion and the one end bent after the closure is inserted into the casing.

2. A closure-fixing structure according to claim 1, wherein said at least one projecting portion is formed with a process on a side opposite to the at least one projecting portion by projecting a wall of the casing inwardly.

3. A closure-fixing structure according to claim 1, wherein an outer peripheral surface of the closure is closely fitted to an inner peripheral surface of the casing by a coining process after the closure is inserted into the casing.

4. A closure-fixing structure according to claim 1, wherein said at least one projecting portion is formed in a series of projections with an interval along a circumference of an inner surface of the casing.

5. A closure-fixing structure according to claim 4, wherein each of said projections is formed in a rib shape extending along the circumference of the inner surface of the casing.

6. A closure-fixing structure according to claim 4, wherein each of said projections is formed in a dimple shape.

7. A closure-fixing structure, comprising:
a casing formed in a cylindrical shape and having two ends to be bent radially inwardly of the casing, and
a closure formed in a disk shape to be inserted into the casing from one of the two ends of the casing for closing the one end, said closure having an outer peripheral surface closely fitted to an inner peripheral surface of the casing by being subjected to a coining process after the closure is disposed in the casing with the bent one end.

8. An inflator, comprising the closure-fixing structure having the cylindrical casing with the two ends and the closure fixed to the casing according to claim 1, a gas generator filled in the casing, and reaction starting means disposed in the casing for initiating a reaction of the gas generator.
